(19) United States
(12) Patent Application Publication
(10) Pub. No.: US 2020/0156644 A1
(43) Pub. Date: May 21, 2020

(54) APPARATUS FOR MANAGING DRIVING LANE OF VEHICLE, SYSTEM INCLUDING SAME AND METHOD THEREOF

(71) Applicants: HYUNDAI MOTOR COMPANY, Seoul (KR); KIA MOTORS CORPORATION, Seoul (KR)

(72) Inventors: Su Hong CHAE, Hwaseong-si (KR); Na Eun YANG, Hwaseong-si (KR); Seung Yong LEE, Suwon-si (KR); Tae Sung CHOI, Hwaseong-si (KR)

(73) Assignees: HYUNDAI MOTOR COMPANY, Seoul (KR); KIA MOTORS CORPORATION, Seoul (KR)

(21) Appl. No.: 16/395,530

(22) Filed: Apr. 26, 2019

(30) Foreign Application Priority Data
Nov. 16, 2018 (KR) 10-2018-0142004

(51) Int. Cl. B60W 30/18; B60W 30/12; G08G 1/16

(52) U.S. Cl. CPC B60W 30/18163; G08G 1/167; B60W 30/12

(57) ABSTRACT

An apparatus for managing a driving lane of a vehicle includes: a processor that generates first route information based on a current lane in which a host vehicle travels when generation of lane-based route information based on a current location of the host vehicle is desired. In particular, the processor generates second route information based on a target lane to which the host vehicle moves when a lane change of the vehicle is desired. And the apparatus further includes a storage that stores the lane-based route information, the first route information and the second route information generated from the processor.

### CROSS-REFERENCE TO RELATED APPLICATION

This application claims priority to and the benefit of Korean Patent Application No. 10-2018-0142004, filed on Nov. 16, 2018, the entire contents of which are incorporated herein by reference.

### FIELD

The present disclosure relates to an apparatus for managing a driving lane of a vehicle, a system including the same, and a method thereof.

### BACKGROUND

The statements in this section merely provide background information related to the present disclosure and may not constitute prior art.

While a vehicle is travelling, a navigation system constitutes a route along which the vehicle is to travel on the basis of the departure place and the destination, and on the basis of the information inputted in advance, guides which lane the vehicle is to travel for the convenience of a user when the road is branched.

As described above, when guiding a route, for example, to which lane the vehicle is to travel, since information about all cases of road branching is desired to be stored, the amount of data to be stored is very large, so that a large amount of storage capacity for storing the data is consumed.

In addition, we have discovered that it is difficult to provide accurate vehicle position and all configuration information in units of lane to be driven, so that convenience and efficiency of the user are somewhat deteriorated.

### SUMMARY

The present disclosure has been made to solve the above-mentioned problems occurring in the prior art while advantages achieved by the prior art are maintained intact.

An aspect of the present disclosure provides an apparatus for managing a driving lane of a vehicle, which is capable of providing a lane information-based route while driving on the basis of a navigation route, grasping a time point when a lane change is desired, and providing lane change information to a vehicle system or a user.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for managing a driving lane of a vehicle may include: a processor that generates first route information based on a current lane in which a host vehicle travels when generation of lane-based route information based on a current location of the host vehicle is desired and generates second route information based on a target lane to which the host vehicle moves when a lane change of the host vehicle to the target lane is desired; and a storage that stores the lane-based route information, the first route information and the second route information generated from the processor.

The processor may determine whether the generation of the lane-based route information based on the current location of the host vehicle is desired.

The processor may determine whether the lane-based route information exists that is generated based on the current location of the host vehicle, and determine whether the generation of the lane-based route information is desired based on whether the current location of the host vehicle is located in a lane-based route when the lane-based route information exists.

The processor may generate the first route information based on a navigation route and a precise map.

The processor may generate the first route information while storing route link information in increasing order of links based on the currently located lane of the host vehicle.

The processor may determine that the lane change is desired when the host vehicle travels in a specified section along the current lane based on the first route information and deviates from the navigation route.

The processor may search for a lane included in the navigation route among lanes closest to the current lane to generate first lane change time point information when the lane change is desired.

The processor may search for a route connection from a point where the host vehicle deviates from the navigation route to the current location of the host vehicle inversely on the current lane maintenance based route, and generate second lane change time point information based on a point where the route connection is disconnected.

The first lane change time point information and the second lane change time point information may include a number of lanes to move and information about a distance from the current lane to a changed lane.

The processor may output the first route information, the first lane change time point information and the second lane change time point information.

According to another aspect of the present disclosure, a vehicle system includes: a vehicle driving lane management apparatus that generates first route information based on a current lane in which a host vehicle travels when generation of lane-based route information based on a current location of the host vehicle is desired and generates second route information based on a target lane to which the host vehicle moves when a lane change of the host vehicle to the target lane is desired; and a precise map database that provides a lane-based precise map to the vehicle driving lane management apparatus.

The vehicle system may further include a navigation device that provides a road-based navigation route to the vehicle driving lane management apparatus.

The vehicle system may further include a display that displays the second route information, which is generated from the vehicle driving lane management apparatus.

The vehicle system may further include an autonomous device configured to control autonomous driving based on the second route information, which is generated from the vehicle driving lane management apparatus.

According to still another aspect of the present disclosure, a method of managing a driving lane of a vehicle includes: generating, by a processor, first route information based on a current lane in which a host vehicle travels when generation of lane-based route information based on a current location of the host vehicle is desired; determining, by the processor, whether a lane change of the host vehicle to a target lane is desired based on the current lane maintenance based route; and generating, by the processor, second route information based on the target lane when the lane change is desired.

The method may further include determining whether the generation of lane-based route information is desired based on the current location of the host vehicle.

The determination of whether the generation of the lane-based route information is desired may include determining whether the lane-based route information generated based on the current location of the host vehicle exists, and determining whether the generation of the lane-based route information is desired based on whether the current location of the host vehicle is located in a lane-based route when the lane based route information exists.

The generating of the first route information may include generating the first route information based on a navigation route and a precise map, and generating the first route information while storing route link information in increasing order of links based on the currently located lane of the host vehicle.

The determining of whether the lane change is desired may include determining that the lane change is desired when the host vehicle travels in a specified section along the current lane based on the first route information and deviates from a navigation route.

The generating of the second route information may include searching for a lane included in the navigation route among lanes closest to the current lane to generate first lane change time point information, and searching for a route connection from a point where the host vehicle deviates from the navigation route to the current location of the host vehicle inversely on the current lane maintenance-based route to generate second lane change time point information based on a point where the route connection is disconnected.

The generating of the second route information may include outputting the first route information, the first lane change time point information and the second lane change time point information.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of a vehicle system including an apparatus for managing a driving lane of a vehicle;

FIG. 2 is a view illustrating an example of a navigation route;

FIG. 3 is a view illustrating a case where a vehicle deviates from a navigation route when traveling in a lane keeping route;

FIG. 4 is a view illustrating a method of calculating a lane change route;

FIG. 5 is a flowchart illustrating a method of managing a driving lane of a vehicle; and

FIG. 6 is a block diagram illustrating a computer system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, a detailed description of well-known features or functions will be ruled out in order not to unnecessarily obscure the gist of the present disclosure.

In describing the components of the present disclosure, terms like first, second, “A”, “B”, (a), and (b) may be used. These terms are intended solely to distinguish one component from another, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure discloses a configuration of generating current lane-based first route information (current lane maintenance based lane information) based on a current location of the host vehicle, and generating second route information (lane change route information) based on a lane to be changed by grasping a case where a lane change is desired.

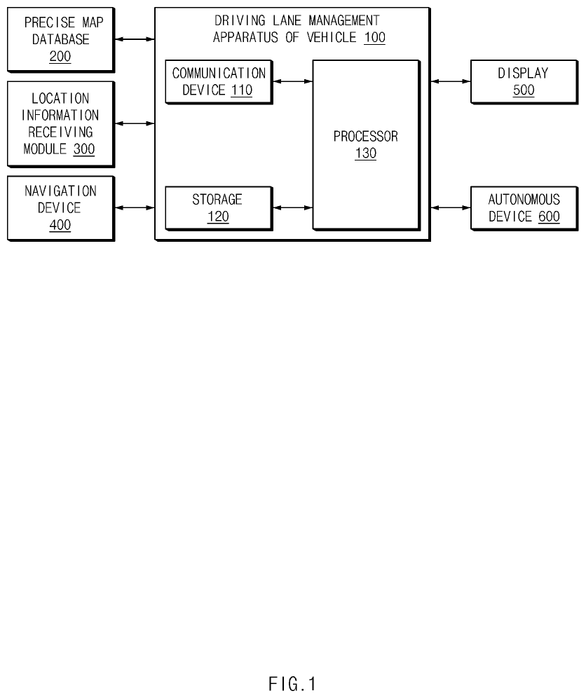

Hereinafter, exemplary forms of the present disclosure will be described in detail with reference to FIGS. 1 to 6.

FIG. 1 is a block diagram illustrating a configuration of a vehicle system including an apparatus for managing a driving lane of a vehicle in one form of the present disclosure.

Referring to FIG. 1, a vehicle system may include an a driving lane management apparatus 100, a precise map database 200, a location information receiving module 300, a navigation device 400, a display 500, and an autonomous device 600.

When it is desired to generate lane-based route information based on the current location of the host vehicle, the driving lane management apparatus 100 generates first route information based on a current lane in which the host vehicle is traveling, generates second route information based on a target lane to which the host vehicle moves when a lane change of the host vehicle to the target lane is desired, and provides the first and second route information to the display 500 or the autonomous device 600. In this case, the lane information-based route information means route information including lane information of a road on a road information-based navigation route. In addition, the first route information based on the current lane means the route information that allows the host vehicle to continuously travel while maintaining a currently located lane, and the second route information based on the target lane is information (the number of lanes to move, moving distance, and the like) at a time point when the lane change is desired.

The driving lane management apparatus 100 may include a communication device 110, a storage 120, and a processor 130.

The communication device 110 may be a hardware device implemented with various electronic circuits for transmitting and receiving a signal through a wireless or wired connection. In the present disclosure, the communication device 110 may perform in-vehicle communication through CAN communication, LIN communication, or the like, and may communicate with the display 500, the autonomous device 600, and the like.

The storage 120 may store first route information based on a current lane, second route information based on the target lane to which the host vehicle moves, lane-based route information, and the like, obtained by the processor 130. The storage 120 may include a storage medium having at least one type of a flash memory type, a hard disk type, a micro type, a card type of a memory (for example, an SD, XD memory, or the like), RAM (Random Access Memory), SRAM (Static RAM), ROM (Read-Only Memory), EEPROM (Electrically Erasable Programmable Read-Only Memory), PROM (Programmable Read-Only Memory), MRAM (Magnetic RAM), a magnetic disc, and an optical disc.

The processor 130 may be electrically connected to the communication device 110 and the storage 120, and may electrically control each component. The processor 130 may be a circuit that executes software commands and may perform various data processing and calculations described below.

When it is desired to generate the lane-based route information based on the current location of the host vehicle, the processor 130 may generate the first route information based on a current lane in which the host vehicle is traveling, and may generate the second route information based on a target lane to which the host vehicle moves when a lane change is desired. In this case, the processor 130 may determine whether it is desired to generate the lane-based route information based on the current location of the host vehicle. That is, the processor 130 determines whether there is a need to generate the lane based route based on whether there exists the lane-based route information generated based on the current location of the host vehicle and whether the current location of the host vehicle is located in a lane-based route when there exists the lane-based route information.

When there is no need to generate the lane-based route, the processor 130 generates output information based on the previous lane-based route information without generating the first route information based on the current lane, and provides the output information to the display 500 or the autonomous device 600.

Meanwhile, when it is desired to generate the lane-based route, the processor 130 may generate the first route information based on the current lane based on the navigation route and the precise map. In this case, the processor 130 may generate the first route information based on the current lane while storing the link information of the route in increasing order of links based on the currently located lane of the host vehicle.

In addition, when the vehicle continues to travel in the current lane based on the first route information based on the current lane in a specified section, the processor 130 may determine that the lane change is desired when the vehicle departs from the navigation route.

When the processor 130 determines that the lane change is desired, that is, when the vehicle continues to travel in the current lane, the processor 130 may search for a lane included in the navigation route among lanes closest to the link before the vehicle deviates from the current lane to generate first lane change time point information. In this case, the processor 130 may search for a route connection from a point where the host vehicle deviates from the navigation route to the current location of the host vehicle inversely on the current lane maintenance-based route, and generate second lane change time point information based on a point where the route connection is disconnected. In this case, the first lane change time point information and the second lane change time point information may include a number of lanes to move and information about a distance from the current lane to a changed lane (e.g., a target lane).

The processor 130 may generate the first route information, the first lane change time point information, and the second lane change time point information based on the current lane as output information, and output the generated information to the display 500 or the autonomous device 600. That is, the processor 130 may output the information about the distance from the current lane to the point at which the changed lane is desired and the lane change time point information.

The precise map database 200 stores lane-based precise map information and provides a precise map to the driving lane management apparatus 100 of the vehicle every specified time period.

The location information receiving module 300 receives location information (GPS) every specified time period and provides the location information to the driving lane management apparatus 100 of the vehicle.

The navigation device 400 provides route information to a destination, wherein the navigation route is road-based route information.

The display 500 may display the lane-based route information, the lane change information determined by the driving lane management apparatus 100 of the vehicle, and the like. The display 500 may be implemented with a head-up display (HUD), a cluster, an audio video navigation (AVN), or the like. In addition, the display 500 may receive color input directly from a user through a user setting menu (USM) of the cluster. In addition, the display 500 may include at least one of a liquid crystal display (LCD), a thin film transistor liquid crystal display (TFT LCD), a light emitting diode (LED), an organic light-emitting diode (OLED), an active matrix OLED (AMOLED), a flexible display, a bended display, and a three-dimensional display (3D) display. Some of these displays may be implemented with transparent displays that are transparent or optically transparent to viewing an outside therethrough. In addition, the display 500 is implemented with a touch screen including a touch panel, and may be used as an input device in addition to an output device.

The autonomous device 600 may correct an autonomous driving route based on the lane change information received from the driving lane management apparatus 100 of the vehicle and may perform the vehicle control based on the corrected autonomous driving route.

For such autonomous driving control, the vehicle system may include a steering control device for controlling a steering angle of the vehicle, an engine control device for controlling engine driving of the vehicle, and a braking control device for controlling braking of the vehicle, but the detailed description will be omitted.

As described above, according to one form of the present disclosure, the navigation route is provided based on the lane, and the time point when the lane change is desired is grasped in advance and outputted to the autonomous device or the display, such that the time point when the lane change is desired is actively reflected onto the lane-based route information to perform autonomous driving or a route guide, thereby increasing the convenience of a user and the efficiency of the autonomous device.

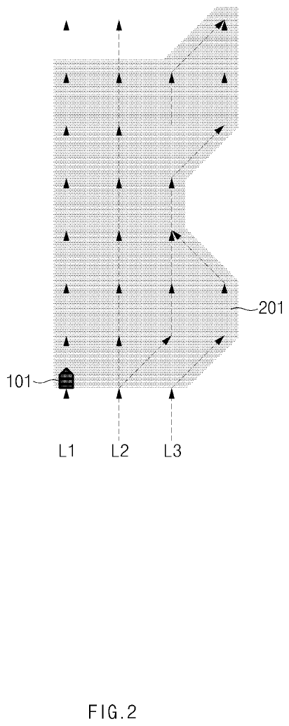

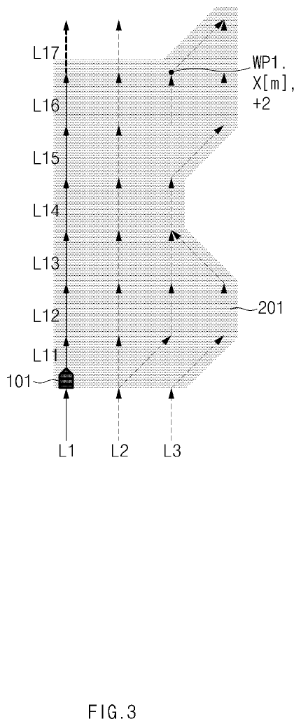

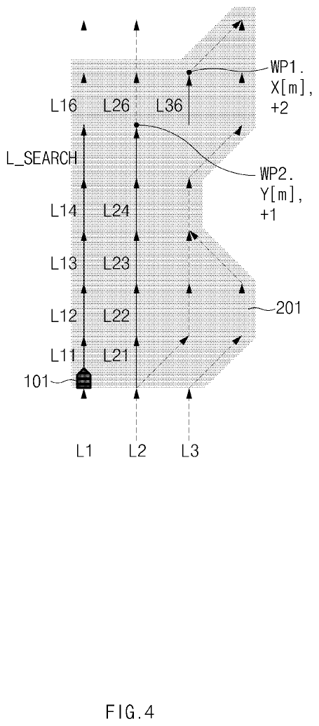

FIG. 2 is a view illustrating an example of a navigation route according to another form of the present disclosure. FIG. 3 is a view illustrating a case where a vehicle deviates from a navigation route when traveling in a lane keeping route according to an exemplary form of the present disclosure. FIG. 4 is a view illustrating a method of calculating a lane change route according to one form of the present disclosure.

Referring to FIG. 2, the driving lane management apparatus 100 may generate a driving route from the current location to the destination when the destination is inputted at the starting time based on the location information and the navigation information. In addition, the driving lane management apparatus 100 may receive the precise map and map the lane information onto the driving route generated based on the navigation information. In this case, since the precise map desires the large storage capacity, the precise map may be received every specified time period (e.g., every traveling distance of 2 km), and the driving lane management apparatus 100 may newly construct route information including lane information every time when the precise map is received.

That is, when the driving lane management apparatus 100 of the vehicle receives the location information, the precise map information and the navigation route information, the driving lane management apparatus 100 generates and outputs the road information including the lane information on the route from the current location to the destination. That is, the driving lane management apparatus 100 of the vehicle may grasp the current location information of a vehicle 101 based on the received location information, a driving route 201 based on the navigation route information, and lane information L1, L2 and L3 on the traveling route based on the precise map information. That is, the precise map includes link information L11, L12, L13, . . . for each lane L1, L2 and L3 including the connection information of each lane for each lane.

In addition, the driving lane management apparatus 100 of the vehicle determines whether the lane information-based route information exists at the current location every specified time period. When the lane information-based route information does not exist, the driving lane management apparatus 100 determines that the generation of the lane information-based route information is desired. That is, the driving lane management apparatus 100 confirms whether the lane-based route information is generated in a section (e.g., a section of 2 km from the current location) which is previously specified based on the current location of the host vehicle. When there is no lane-based route information, the driving lane management apparatus 100 determines that the generation of the lane information-based route information is desired. In addition, even though there exists the lane information-based route information, when the location of the host vehicle in the lane information-based route information is different from the actual location of the host vehicle, the driving lane management apparatus 100 of the vehicle determines that the vehicle deviates from the route and the generation of new lane information-based route information is desired.

Such generation of the lane information-based route information will be described with reference to FIG. 3.

Referring to FIG. 3, the driving lane management apparatus 100 of the vehicle generates the first route information based on the current lane in which the vehicle can travel while maintaining the current lane in order to generate the lane information-based route information. That is, the driving lane management apparatus 100 of the vehicle generates the first route information based on the current lane that the vehicle can continue to travel while maintaining the current lane.

In this case, the driving lane management apparatus 100 of the vehicle constructs a route until the vehicle deviates from the navigation guidance route while following the link information of the precise map without changing the route. This search may continue until there is no corresponding information, depending on the storage capacity of hardware, the amount of received data on the precision map, or when the vehicle reaches a departure route.

The driving lane management apparatus 100 of the vehicle constructs a route while storing the link information of the lane route from start link L11 to links L12 to L16 on the basis of the lane where the vehicle is currently located. In this case, when the driving lane management apparatus 100 of the vehicle is able to continue to travel without changing the lane, that is, when the vehicle does not deviate from the navigation route even if the vehicle continues to travel without changing the lane in a specified section, the driving lane management apparatus 100 generates output information without lane change based on first route information based on the current lane.

However, as shown in FIG. 3, when the vehicle travels to the links L11 to L17 of the current route, it may be determined that the link L17 is not included in a navigation route 201. That is, in this case, when the vehicle continues to travel to the current driving lane L1 and reaches the link L17, the driving lane management apparatus 100 may know that the vehicle deviates from the navigation route 201. In this case, as the navigation route is road-based route information, when the vehicle should be driven in a right lane for turning right in front, exiting an interchange (IC) in front, and the like, as shown in FIG. 3, the navigation route may include only two right lanes among four lanes.

That is, when the vehicle reaches a departure route L7, it is determined that there is a need to change a lane on the navigation route 201 within the same road, and the lane change route is calculated.

Referring to FIG. 4, the driving lane management apparatus 100 of the vehicle determines that the lane change is desired at a time point L16 at which it is estimated that the host vehicle deviates from the navigation route 201 when the host vehicle continuously travels in the current lane at the current location, and searches for an adjacent lane which is closest to the current lane and does not deviate from the navigation route. In FIG. 4, link L36 is closest to link L16 and does not deviate from the navigation route. The point at which the link L36 ends is stored as a lane change point WP1, X (m). Then, the driving lane management apparatus 100 of the vehicle determines whether an additional lane change is desired while searching for a route from the lane change point WP1, X (m) inversely to the current location of the host vehicle.

In FIG. 4, with respect to the current lane keeping based route from the link L1 to the link L6, it is performed to search for a disconnected location in the lane by searching inversely from the link L36 to the current location of the host vehicle with the lane change point WP1 and X (m) as the start point. In case of the link L36, it may be understood the link L36 is disconnected in the downward direction and is broken.

As described above, when there is no connected road, the driving lane management apparatus 100 of the vehicle sets the lane closest to the current lane as a next lane change point WP2, Y (m) and stores the corresponding information.

In such a manner, the driving lane management apparatus 100 of the vehicle performs a reverse search to the current location of the vehicle to store the lane change points. That is, the driving lane management apparatus 100 of the vehicle searches for the lane closest to the current lane and stores the number of lanes to move and distance information (WP1, distance [m], and the number of lanes to move based on the current lane). In addition, the driving lane management apparatus 100 of the vehicle may store and output a predefined lane number or all lane information on the corresponding route.

The driving lane management apparatus 100 of the vehicle stores the first route information based on the current lane, and the lane change point information WP desired for the lane change in the current lane. In FIG. 4, the first route information L11 to L15 based on the current lane, and the lane change point information WP1 and WP2 are stored. In FIG. 4, as an example, the closest lane change point is WP2, which means that it is desired to move right by one line within Y [m] to the corresponding lane change point WP2. In this case, ‘+’ may be defined to change as changing to a right lane and ‘−’ may be defined as changing to a left lane. However, as well as the first route information based on the current lane and the lane change point information, the corresponding lane number or all lane information may be outputted.

The vehicle system may control vehicle driving in an autonomous mode by using the first route information based on the current lane, and the lane change point information WP desiring the lane change in the current lane. In addition, the driving lane management apparatus 100 of the vehicle displays the first route information based on the current lane and the lane change point information WP desiring the lane change in the current lane on a display (e.g., HMI) for guiding a user, thereby allowing the user to drive the vehicle along the lane information-based route.

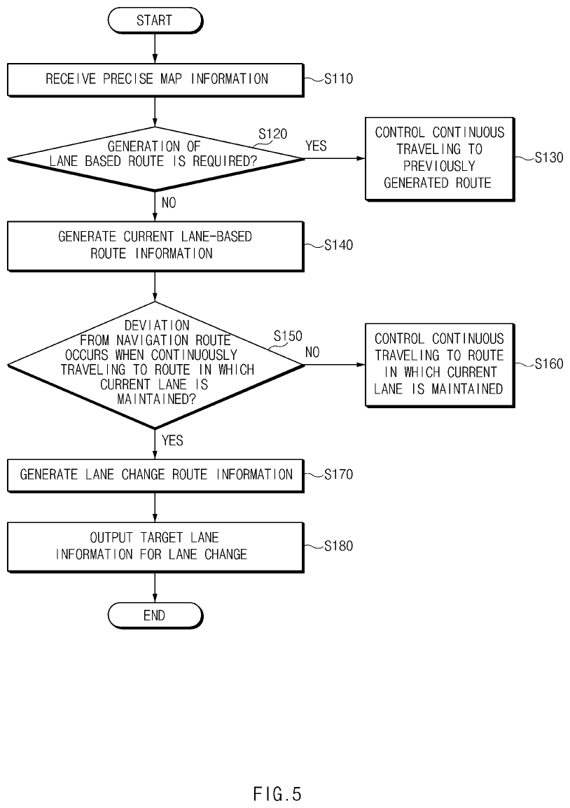

Hereinafter, a method of managing a driving lane of a vehicle according to one form of the present disclosure will be described in detail with reference to FIG. 5. FIG. 5 is a flowchart illustrating the method of managing a driving lane of a vehicle.

In the following description, it is assumed that the apparatus 100 of FIG. 1 performs the process of FIG. 5. In addition, it may be understood that the operations described as being performed by the apparatus are controlled by the processor 130 of the apparatus 100.

Referring to FIG. 5, in operation 5110, the driving lane management apparatus 100 of the vehicle receives the precise map information every specified time period. In this case, the driving lane management apparatus 100 of the vehicle may receive the location information from the location information receiving module 300 every specified time period, and the navigation route may be calculated and provided by the navigation device 400 when the destination is input.

In operation S120, the driving lane management apparatus 100 of the vehicle determines whether the lane information-based route information exists on the basis of the current location of the host vehicle and whether the current location of the host vehicle is located in the lane information-based route in order to determine whether the generation of the lane information-based route information is desired. That is, when the lane information-based route information based on the current location of the host vehicle does not exist or the current location of the host vehicle deviates from the lane information-based route information even though the lane information-based route information exists, the driving lane management apparatus 100 of the vehicle determines that the generation of the lane information-based route information is desired. The lane information-based route information means route information including the lane information of the road on the navigation route based on the road information.

When the route information based on the lane already exists and the current location of the host vehicle is located on the lane based route in the operation S120, in operation S130, the driving lane management apparatus 100 of the vehicle may determine that there is no need to generate the lane-based route information and may continuously output the lane-based route information previously generated, such that the driving lane management apparatus 100 controls the vehicle to continuously travel to the lane-based route previously generated.

Meanwhile, when there is a need to generate the lane information-based route in operation S120, in operation S140, the driving lane management apparatus 100 of the vehicle generates the first route information based on the current lane. That is, the route information that allows the vehicle to continuously travel is generated based on the current lane.

Thus, in operation S150, the driving lane management apparatus 100 of the vehicle determines whether the vehicle deviates from the navigation route when continuously traveling in the current lane maintenance based route. In operation S160, when the vehicle does not deviate from the navigation route when continuously traveling in the current lane maintenance based route, the driving lane management apparatus 100 of the vehicle may output the first route information based on the current lane and may control the vehicle to continuously travel in the current lane maintenance based route.

When it is determined in operation S150 that the vehicle deviates from the navigation route when continuously traveling in the current lane maintenance based route, in operation S170, the driving lane management apparatus 100 of the vehicle generates the second route information (target lane information) based on the lane to be changed (i.e., a target lane) to which the host vehicle moves such that the vehicle is inhibited or prevented from deviating from the navigation route. That is, the driving lane management apparatus 100 searches for a lane change point to a lane which is included in the navigation route among nearby lanes closest to the route departure point and then searches inversely to the location of the host vehicle, thereby generating the second route information based on the lane to be changed.

Thereafter, in operation S180, the driving lane management apparatus 100 of the vehicle outputs the second route information based on the lane to be changed. In this case, the second route information based on the lane to be changed is displayed on the display 500 to be confirmed by the user, or may be provided to the autonomous driving device to be used during autonomous driving.

As described above, according to the present disclosure, the precise map including the lane information during traveling in the navigation route is received every specified time period to provide the lane information based route information, and the second route information based on the lane to be changed at the time when the lane change of the host vehicle is desired is generated by determining whether the lane change is desired at the current lane of the host vehicle to the inform the autonomous driving device or the user of it, so that the vehicle can travel more safely and conveniently.

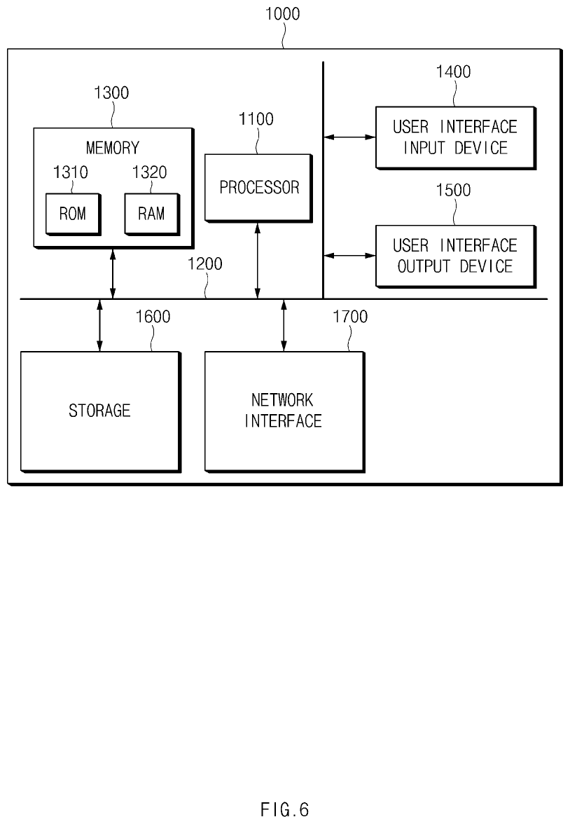

FIG. 6 is a block diagram illustrating a computer system according to one form of the present disclosure.

Referring to FIG. 6, a computing system 1000 may include at least one processor 1100, a memory 1300, a user interface input device 1400, a user interface output device 1500, storage 1600, and a network interface 1700, which are connected to each other through a bus 1200.

The processor 1100 may be a central processing unit (CPU) or a semiconductor device which performs processing for instructions stored in the memory device 1300 and/or the storage 1600. The memory 1300 and the storage 1600 may include various types of volatile or non-volatile storage media. For example, the memory 1300 may include a read only memory (ROM) and a random access memory (RAM).

The operations of a method or algorithm described in connection with the forms disclosed herein may be embodied directly in hardware, in a software module executed by the processor 1100, or in a combination of the two. The software module may reside in a storage medium (that is, the memory 1300 and/or the storage 1600) such as a random access memory (RAM), a flash memory, a read only memory (ROM), an erasable programmable ROM (EPROM), an electrically erasable programmable ROM (EEPROM), registers, hard disk, a removable disk, a compact disc-ROM (CD-ROM), etc.

An exemplary storage medium is coupled to the processor 1100 such that the processor 1100 may read information from, and write information to, the storage medium. Alternatively, the storage medium may be integrated into the processor 1100. The processor and the storage medium may reside in an ASIC. The ASIC may reside within a user terminal. Alternatively, the processor and the storage medium may reside in the user terminal as individual components.

This technology may provide a lane information-based route while driving on the basis of a navigation route, grasp a time point when a lane change is desired, and provide lane change information to a vehicle system or a user, thereby improving the user convenience and increasing the efficiency of the system.

In addition, various effects that are directly or indirectly understood through the present disclosure may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. An apparatus for managing a driving lane of a vehicle, the apparatus comprising:
a processor configured to:
generate first route information based on a current lane in which a host vehicle travels when generation of lane-based route information based on a current location of the host vehicle is requested, and
generate second route information based on a target lane to which the host vehicle moves when a lane change of the host vehicle to the target lane is requested; and
a storage configured to store the lane-based route information, the first route information and the second route information generated from the processor.

2. The apparatus of claim 1, wherein the processor is configured to determine whether the generation of the lane-based route information based on the current location of the host vehicle is desired.

3. The apparatus of claim 2, wherein the processor is configured to:
determine whether the lane-based route information exists that is generated based on the current location of the host vehicle; and
determine whether the generation of the lane-based route information is desired based on whether the current location of the host vehicle is located in a lane-based route when the lane-based route information exists.

4. The apparatus of claim 1, wherein the processor is configured to generate the first route information based on a navigation route and a map.

5. The apparatus of claim 4, wherein the processor is configured to generate the first route information while storing route link information in increasing order of links based on the currently located lane of the host vehicle.

6. The apparatus of claim 4, wherein the processor is configured to determine that the lane change is desired when the host vehicle travels in a specified section along the current lane based on the first route information and deviates from the navigation route.

7. The apparatus of claim 4, wherein the processor is configured to search for a lane included in the navigation route among lanes closest to the current lane and to generate first lane change time point information when the lane change is desired.

8. The apparatus of claim 7, wherein the processor is configured to search for a route connection from a point where the host vehicle deviates from the navigation route to the current location of the host vehicle inversely on a current lane maintenance based route, and configured to generate second lane change time point information based on a point where the route connection is disconnected.

9. The apparatus of claim 8, wherein the first lane change time point information and the second lane change time point information include a number of lanes to move and information about a distance from the current lane to a changed lane.

10. The apparatus of claim 8, wherein the processor is configured to output the first route information, the first lane change time point information and the second lane change time point information.

11. A vehicle system comprising:
a vehicle driving lane management apparatus configured to:
generate first route information based on a current lane in which a host vehicle travels when generation of lane-based route information based on a current location of the host vehicle is desired; and
generate second route information based on a target lane to which the host vehicle moves when a lane change of the host vehicle to the target lane is desired; and
a map database configured to provide a lane-based precise map to the vehicle driving lane management apparatus.

12. The vehicle system of claim 11, further comprising:
a navigation device configured to provide a road-based navigation route to the vehicle driving lane management apparatus; and
a display configured to display the second route information, which is generated from the vehicle driving lane management apparatus.

13. The vehicle system of claim 11, further comprising:
an autonomous device configured to control autonomous driving based on the second route information, which is generated from the vehicle driving lane management apparatus.

14. A method of managing a driving lane of a vehicle, the method comprising:
generating, by a processor, first route information based on a current lane in which a host vehicle travels when generation of lane-based route information based on a current location of the host vehicle is desired;
determining, by the processor, whether a lane change of the host vehicle to a target lane is desired based on a current lane maintenance based route; and
generating, by the processor, second route information based on the target lane when the lane change is desired.

15. The method of claim 14, further comprising:
determining whether the generation of lane-based route information is desired based on the current location of the host vehicle.

16. The method of claim 15, wherein the determination of whether the generation of the lane-based route information is desired includes:
determining whether the lane-based route information generated based on the current location of the host vehicle exists; and
determining whether the generation of the lane-based route information is desired based on whether the current location of the host vehicle is located in a lane-based route when the lane based route information exists.

17. The method of claim 16, wherein the generating of the first route information includes:
generating the first route information based on a navigation route and a precise map; and
generating the first route information while storing route link information in increasing order of links based on the currently located lane of the host vehicle.

18. The method of claim 14, wherein the determining of whether the lane change is desired includes:
determining that the lane change is desired when the host vehicle travels in a specified section along the current lane based on the first route information and deviates from a navigation route.

19. The method of claim 14, wherein the generating of the second route information includes:
searching for a lane included in a navigation route among lanes closest to the current lane to generate first lane change time point information; and
searching for a route connection from a point where the host vehicle deviates from the navigation route to the current location of the host vehicle inversely on the current lane maintenance-based route to generate second lane change time point information based on a point where the route connection is disconnected.

20. The method of claim 19, wherein the generating of the second route information includes:
outputting the first route information, the first lane change time point information and the second lane change time point information.
